(19) United States
(12) Patent Application Publication
(10) Pub. No.: US 2016/0144447 A1
(43) Pub. Date: May 26, 2016

(54) Welding Process Gas Metal Arc Welding - Double Cold Wire (GMAW-DCW)

(71) Applicant: UNIVERSIDADE FEDERAL DO PARÁ - UFPA, Belém - PR (BR)

(72) Inventors: Eduardo de Magalhaes BRAGA, Belem (BR); Paulo Dangelo Costa ASSUNCAO, Belem (BR)

(21) Appl. No.: 14/900,789

(22) PCT Filed: Jun. 26, 2014
(86) PCT No.: PCT/BR2014/000211

§ 371 Date: Dec. 22, 2015

(30) Foreign Application Priority Data
Jun. 25, 2013 (BR) BR1020130188689

(51) Int. Cl. B23K 9/173

(52) U.S. Cl. CPC B23K 9/1735

(57) ABSTRACT

Patent of a process that consists of a coupling a fixing split clamp to the torch (2) in a injecting device of two “cold” wires a to a welding torch (14) that is connected to the electrode wire head (12), which is also connected to the welding power source (11) that establishes the electric arc and the weld pool, the two “cold” wires are boosted by auxiliary heads (13), lead through the conduit (17) until the injector tube (8), which is fastened to the injector tube basis (7) by brake bolts (10) and therefore the injector tube (8) may dislocate horizontally to the welding torch, also enabling the injector tube (8) to make a turn perpendicular to the welding torch, these two movements determine the input angle of the “cold” wires in relation to the electrode wire (torch wire) and between the two “cold” wires. The “cold” wires pass through the contact nozzles (9) which are made of electrolytic copper and they have the function of leading “cold” wires as close as possible to the electric arc to prevent vibrations and disturbance in the wire.

This invention refers to a process in which two wires not energized are injected two by auxiliary heads in the electric arc generated by 5 the electrode wire, with the purpose of performing welding for joining and coating metal. The process can be used for both GMAW (Gas Metal Arc Weld) and FCAW (Flux Cored Arc Weld) processes.

The GMAW and the FCAW welding processes are already known and consolidated, where the arc is established between the workpiece and a consumable in a wire shape that are fed continuously. The arc casts the wire as it is fed to the weld pool. The weld metal is protected from the atmosphere by the gas flow (or gas mixture) inert or active, as well as for the gas and the slag. These welding processes are widely used when a greater productivity or a robot welding is needed.

Despite the widespread use of these welding processes, some drawbacks can be attributed to him, for example, the need in industry for greater productivity. In spite of the existing processes having high productivity, when compared to manual process—Shielded Metal Arc Welding—SMAW, the industrial demand requires more productive processes, especially when they are used in automated welding and/or robot welding, because with the robot usage the weld puddle displacement is more uniform and the welding speed is a lot higher.

Another problem noted by GMAW and FCAW processes is related to permanent deformation of the welded parts, which is a consequence of the high thermal cycle caused by high welding current, which has a direct relation with the wire feed speed, in other words, the higher the wire feed for the higher productivity, the higher the welding current supplied by the source and the higher the permanent deformation on this material.

Given those observations and in order to overcome them it was developed the welding process Gas Metal Arc Welding-Double Cold Wire (GMAW-DCW), the subject of this patent, which is the introduction of two “cold” wires in the atmosphere of an arc generated by the energized wire, this way, the “cold” wires cast with the energized wire together, adding the material deposited in the weld pool.

This new process increases the rate of material deposition, reaching up to 100% more productivity in relation to GMAW and FCAW welding processes, with good levels of arc stability and quality of the welded joint. Different wire diameters can be used, as well as mixing tubular solid wires.

Another advantage observed in this new process is the increase in the reinforcement and the reduction in weld penetration. This fact is characteristic in welding coating, which makes the process promising for application in coating.

The attached figures show the arrangement of the welding process (GMAW-DCW), the patent subject, in which:

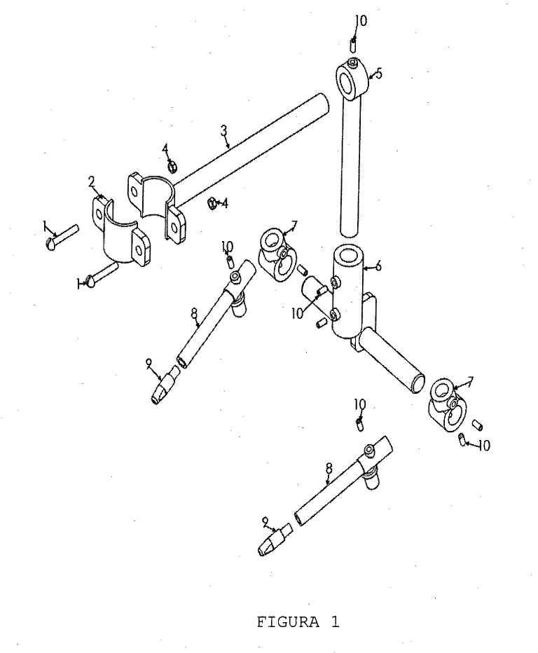

FIG. 1 shows the support of the “cold” wires injectors in exploded perspective.

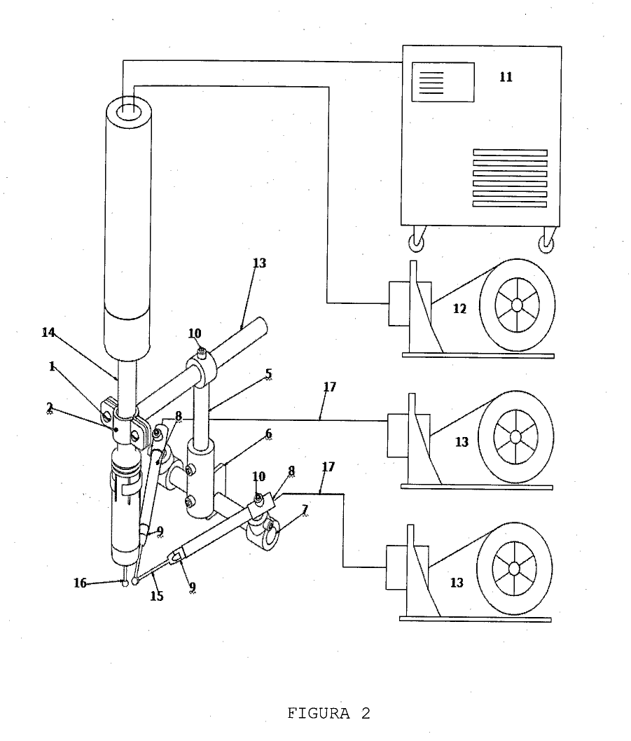

FIG. 2 shows the support with two injectors mounted on the welding torch in perspective.

According to what the illustrations show in the figures listed above, the welding process system (GMAW-DOW), this patent subject, as FIG. 1 shows, consists of a bolt union (1), which connects the fixing clamp to the torch (2), this clamp is attached to this horizontal displacement rod (3), which is fastened by twisting the nut (4) to the bolt (1).

The vertical displacement rod (5), which serves to guide the support of the injector displacement (6), these two sets determine the height of the wires entry in relation to the weld pool, the injector tube bottom (7) can dislocate horizontally to the welding torch, which makes it possible for the injector tube (8) makes a spin perpendicularly to the welding torch, these two movements determine the “cold” wire angle entry in relation to the electrode wire (torch wire) and between the two “cold” wires. The injector tube (8) is a support that receives the conduit (17) that leads the “cold” wire to the contact nozzle of electrolytic copper (9), the brake bolts are used to fasten the movable parts of the device (10).

In FIG. 2 we have the Welding power source (11), the feeding head of the electrode wire (12) which is connected to the source and the auxiliary heads of the “cold” wire injection (13) that has a connection regardless of the power source, we also have the “cold” wires injection device coupled to the welding torch (14) with “cold” wires (15) positioned in the direction of the electrode wire (16), this injection device wire enables the usage of multiple angles and input positions of “cold” wires, because since this is a new process there is a need of performing several experiments. However, this complex device can be manufactured in a more simple way and with fixed angles or less degrees of freedom, thus producing less complex systems to manufacture and handle.

1. Welding process gas metal arc welding-double cold wire (GMAW-DCW) comprised by two “cold” wires which casts in the electric arc or in the weld pool which is protected from the atmosphere by the flow of a gas (or gas mixture) inert or active, this process is considered a highly productive one, because it has a higher deposition rate compared to GMAW or FCAW processes.

2. Welding process gas metal arc welding-double cold wire (GMAW-DCW), the welding process described according to claim 1, is characterized by injecting two “cold” wires, which are boosted by two auxiliary heads that are independent of welding power source, these wires are lead through the conduit of the heads until the injector tubes which are fixed to the injector tube basis where it may dislocate horizontally to the welding torch, also enabling the injector tube makes a spin perpendicularly to the welding torch, this movement that will direct the “cold” wires toward the electric arc to the weld puddle.

3. Welding process gas metal arc welding-double cold wire (GMAW-DCW), the injection device of “cold” wire is connected to the welding torch through a fixing split clamp to the torch being connected by bolts and nuts.

4. Welding process gas metal arc welding-double cold wire (GMAW-DCW), the two “cold” wires may have the same chemical composition of the electrode wire forming a weld metal with metallurgical properties already provided, they may also have a different chemical composition, and thus it is possible to manipulate the metallurgical properties of the weld metal.
